(19) United States
(12) Patent Application Publication
(10) Pub. No.: US 2004/0076838 A1
(43) Pub. Date: Apr. 22, 2004

(54) Spin application of thermally cured coatings

(75) Inventors: Martin L. Hage, Maple Grove, MN (US); Edward de Rojas, Pickerington, OH (US)

Correspondence Address: INSKEEP INTELLECTUAL PROPERTY GROUP, INC, 1225 W. 190TH STREET, SUITE 205, GARDENA, CA, 90248, US

(73) Assignee: Vision-Ease Lens, Inc.

(21) Appl. No.: 10/632,627

(22) Filed: Jul. 31, 2003

Related U.S. Application Data
(60) Provisional application No. 60/400,309, filed on Jul. 31, 2002.

(51) Int. Cl. B32B 9/04

(52) U.S. Cl. 428/447; 428/446

(57) ABSTRACT

A thermally curable coating is spin applied to the surface of a lens through a process that comprises the following steps: preparing a thermally curable coating composition, spin applying the coating onto one surface of a lens, and curing the coating. The process combines the best features both of the spin application technique and a thermally cured coating to obtain high productivity with high yield in the application process yet provide superior coating properties without requiring stripping or other pretreatment steps, which have negative attributes. The process can also incorporate the use of either a thermoset or a thermoplastic primer to enhance the coating adhesion.

### RELATED APPLICATIONS

This application claims priority to provisional application Serial No. 60/400,309 filed Jul. 31, 2002, the entire contents of which is incorporated herein by reference.

### BACKGROUND OF THE INVENTION

The present invention relates to a process for applying and forming a thermally curable coating on plastic substrates such as ophthalmic lenses or other optical articles. More specifically, the present invention relates to a spin application process of an abrasion resistant coating to the surface of a semifinished ophthalmic lens subsequent to prescription surfacing.

Ophthalmic lenses made from organic materials, such as bisphenol A polycarbonate, have become popular due to their low cost, high refractive index, high impact resistance, and low density. However, they are more susceptible to surface scratches than mineral glass. The application of an abrasion resistant coating on both the front as well as the back surfaces of an ophthalmic lens of organic material, hereafter a “lens”, is highly beneficial and, in some cases, even necessary.

A lens, either finished or semifinished, is coated at the manufacturing site on both sides through a process such as dip coating or spin coating. Generally two types of coating are usually employed, radiation curable coatings and heat curable coatings. The latter are also known as thermally cured coatings. Most radiation curable coatings are based on acrylate chemistry and are either solvent borne or solventless. They are usually cured by ultraviolet radiation but may also be cured by other wavelengths or even by electron beam. Most heat curable coatings for ophthalmic lenses are siloxane based, made from various siloxane monomers, especially tetraalkoxysilanes and alkyltrialkoxysilanes that have been reacted with water to various extents of hydrolysis. The latter are known as silsesquioxanes and may have various organofunctional moieties attached to the alkyl group that is bonded directly to the central silicon atom. Thermally cured coatings usually have much higher abrasion resistance than radiation curable coatings. However, heat curable siloxane coatings usually require a longer cure time than radiation curable coatings. For example, thermal curable coatings can be found in numerous patents, such as U.S. Pat. Nos. 4,547,397, 5,357,024, 5,385,955, and 6,538,092. Exemplary radiation curable coatings are cited in U.S. Pat. Nos. 4,384,026, 4,478,876, 4,491,508, 5,126,394, and 5,409,965.

At optical or dispensing laboratories, semifinished lenses must be cut, ground, and polished or otherwise surfaced to prescription on the concave surface prior to edging and adjusting the lenses for the frames. This surfacing leaves the concave surface uncoated. Optical or dispensing laboratories may either spin apply or dip apply a coating to the surfaced lens. The technique of spin application is highly desirable for reasons that relate to both yield and reproducibility. These factors are especially important for coating the concave sides of semifinished lenses after they have been surfaced to prescription. In the past, all spin applied coatings were of the radiation curable type, due to the long cure time of the thermally cured coatings. Thus, this process produced lenses with inferior properties to those with thermal coatings.

Most dip applications employ thermally cured coatings, providing superior physical properties to the lenses. However, since the semifinished lenses are sold to the wholesaler or retailers with a coating already-present on the front surface of the lens, dip coating will apply a second layer of coating to the previously coated side. In addition to the added expenses of greater coating consumption and the attendant yield loss of coating two surfaces as opposed to one, applying a coating to a previously coated surface impairs the aesthetic value of the lens as well as the adhesion of the subsequently applied coating. Obtaining desired aesthetics as well as good intercoat adhesion normally requires stripping the first coating or using a pretreatment. Either method requires additional equipment, hazardous materials, and additional process time.

Therefore, there is a need for a coating technique having the best features of the spin application technique and a thermally cured coating, obtaining high productivity and yield without requiring stripping or other pretreatment steps.

### OBJECTS AND SUMMARY OF THE INVENTION

One object of the present invention is to provide a practical process for applying a heat curable coating, to the front or back surface of a lens. In particular, the invention allows for increased yield and quick curing times, yet results in a durable abrasion resistant coating having reduced interference fringes.

Another object of the present invention is to provide a heat curable coating specifically formulated for being cured according to the process of the invention. The process is not only applicable in optical surfacing or dispensing laboratories, but also in lens manufacturing facilities to replace processes such as dip coating for semifinished lenses.

The present invention allows a heat curable abrasion resistant coating to be applied through a spin application process without long process times in the spin coating machine. The processing time for a lens in the spin coating machine is usually less than two minutes. According to the invention, the spin application process for applying a heat curable coating may comprise:

Preparing a coating composition comprising: an aqueous-organic solvent mixture containing the various hydrolysis products and partial condensates of an epoxy functional silane, a tetraalkoxysilane, and a multifunctional compound; the multifunctional compound being selected from a group consisting of multifunctional carboxylic acids, multifunctional anhydrides, and combinations thereof; the epoxy functional siloxane monomer being present in a molar ratio to the tetrafunctional silane from about 0.1:1 to about 5:1; and an amount of water sufficient to hydrolyze the epoxy functional silane and the tetraalkoxysilane;

Spin applying the coating from the previous step to at least one surface of the lens, at a predetermined spin speed and predetermined spin time to provide a desired final cured coating thickness;

Precuring the coating to a tack free state at a predetermined temperature and for a predetermined time;

Transferring the precured lens into an oven to completely cure the coating at a predetermined temperature and for a predetermined time.

The process is not only applicable in optical surfacing or dispensing laboratories, but also in lens manufacturing facilities to replace processes such as dip coating for semifinished lenses.

### DETAILED DESCRIPTION OF THE INVENTION

The application of thermal curable coating can be applied to surfaced semifinished lenses made from any lens material. Preferred lens materials include (meth)acrylic resins, polycarbonate resins, di(ethyleneglycol) bis(allyl carbonate) copolymers, (halogenated) bisphenol A di(meth)acrylate homopolymers and copolymers, and (halogenated) bisphenol A urethane modified di(meth)acrylate homopolymers and copolymers, polyurethanes, polyester, cellulose acetate butyrate; and acrylonitrile butadiene styrene terpolymer. More preferred are lens materials such as di(ethyleneglycol) bis(allyl carbonate) copolymers such as CR-39® from PPG Industries, polycarbonates such as Lexan® from General Electric and Makrolon® from Bayer, and high refractive index resins such as MR-6, MR-7, and MR-8 plastics from Mitsui Toatsu.

Any spin coater equipped with a coating spray cycle and a thermal curing cycle for precuring can be used in the process of this invention. U.S. Pat. No. 5,246,728 describes a spin coating process for applying a radiation curable coating on CR-39® cast lenses. U.S. Pat. No. 5,514,214 discloses an automatic spin coater for applying radiation curable scratch resistant coatings. They are incorporated herein by reference. Spin coaters designed for applying radiation curable coatings can be easily converted for use in the process of this invention, by replacing the radiation curing components with thermal curing components. In some cases, the spin coater for radiation curable coatings already has an infrared heating element in a chamber for thermally accelerating the evaporation of the solvent, drying the lens, and suitable for effecting the precure of a thermally cured coating.

A preferred spin coater should have at least the following processes: washing, drying, coating, and precuring. Several commercial spin coating machines can be used to wash, dry, apply, and precure a thermally cured coating. These machines include an ASC-500 from Calmation and a Super Lens Coater from Lightwave Energy Systems.

According to the first step of an embodiment of the present invention, a thermally cured coating composition based on epoxyalkoxysilanes is prepared. The main components of the curable compositions are well known in the art and are disclosed in U.S. Pat. No. 6,001,163, the disclosure of which is incorporated herein by reference.

A typical thermally cured coating for use with this invention would contain one or more siloxane monomers, one or more alcoholic solvents, deionized or distilled water, one or more acids, one or more slip additives, and one or more fluorosurfactants. The siloxane monomers typically employed include the tetraalkoxysilanes and trialkoxysilanes. The former are known as orthosilicates and the latter are known as silsesquioxanes. Less commonly, dialkoxysilane monomers are also used since they tend to reduce shrink induced stress crazing albeit at a sacrifice in crosslink density, and, concomitantly, some abrasion resistance is conceded as well. The alcoholic solvents that are commonly employed include methanol as well as the primary, secondary, and tertiary hydroxyl bearing lower molecular weight alcohols containing up to four carbon atoms. The alcohols assist in reducing the viscosity but also serve to provide stability against gelation. Alcoholic solvents such as the ether alcohols, which are known as glycol ethers and are derivatives of alkaline oxides, are also widely used due to their coupling ability, good wetting, and tendency to reduce blushing or the formation of a haze on the surface of the film due to the condensation of ambient atmospheric moisture. Sufficient purified water is added to effect as much hydrolysis as possible in order to maximize abrasion resistance without creating blushing or unduly sacrificing solution stability towards gelation. The acids are used to adjust the pH for an optimum balance of stability and cure rate. The slip additive, typically a modified polydimethylsiloxane, is used in sufficient quantity to reduce the coefficient of friction so as to help prevent abrasion, scratches, and other forms of marring, although excessive levels of these materials will actually reduce the abrasion resistance due to an increase in the crosslink equivalent weight. The surfactants are very useful in improving both adhesion as well as cosmetics by improving wetting, flow, and leveling thereby preventing a wide variety of surface or other imperfections in the film that arise from a wide variety of causes. These film imperfections include such surface tension related defects as crawling, picture framing, fish eyes, shiners, pits, pockmarks, orange peel, and Benard cells. The latter are also called vortex cells and result from changes in the surface tension during the drying process, which results from changes in the composition of the coating film as the solvents evaporate. Perfluorinated surfactants are particularly useful for improving the aesthetics of the coating film due to their excellent ability to wet difficult to wet surfaces, most notably plastic or polymeric substrates. This is especially true for those substrates that are injection molded, which tend to be difficult to wet due to the presence of very low surface energy mold release materials that may be used internally or externally. Care must be taken to avoid adding too much of these highly efficacious materials since at higher concentrations they can induce some of the very same coating defects that they are employed to eliminate. Optionally, one or more blue or violet dyes may also be used in the coating formula to counteract any yellowing that may occur during the curing process with some coating formulas, lens materials, or combinations thereof.

According to the second step of the process of the present invention, the coating prepared from the first step is spin applied to one surface of a lens. Before applying the coating, the lens is pretreated to ensure thorough cleaning and adequate adhesion. The pretreatment can be a prewash, soak, surface preparation, or conditioning process that may include some combination of deionizing high pressure clean air spray, high pressure aqueous wash, hand washing, mechanical scrubbing, solvent washing, vapor degreasing, anionic detergent, cationic detergent, nonionic detergent, amphoteric or zwitterionic detergent, ultrasonic energy, aqueous alkali metal hydroxide, ultraviolet light, ozonolysis, corona, plasma, or other means.

A typical pretreatment involves spraying a lens surface with deionizing high pressure clean air just before the lens is placed inside the spin coater, then cleaning the surface with a high pressure deionized water spray at a spin speed of about 1,000 rpm to about 2,000 rpm for about one to twenty seconds. The washed lens can be either spin dried or optionally dried with heat. To spin dry the lens, it is simply spun at the same or higher speed for an additional five to ten seconds. To dry the lens with heat, an infrared or convection heating source is preferred. The lens is spun at a lower speed, from 100 rpm to 500 rpm, for a predetermined time. If necessary, a deionizing clean air spray can be supplied at the drying cycle. It is important that dust and other particles do not settle on the surface of the lens, since that would result in imperfections in the coating film from dust particles being trapped in the coating solution that is being applied in the next stage.

After the pretreatment, the coating is applied by low pressure spray onto the lens while spinning. The coating thickness is controlled and the excess coating is removed from the edge of the lens by spinning at one or more precisely controlled speeds. The time and speed at which the lens is spun after the application of the coating is dependent upon several variables, including the desired dry film thickness, the viscosity of the coating, the weight percent of nonvolatiles in the coating, the temperature of the coating, the temperature of the ambient air, the dew point of the ambient air, the curvature of the surface that is being coated, whether or not the lens is segmented, and other factors.

For a given coating, the spin speed and time for both the application as well as the coating spin off are predetermined by experimentation to achieve a desired wet film thickness. It is preferred to apply the coating solution at a spin speed between about 250 rpm to about 2,000 rpm, more preferably between about 500 rpm and about 1,000 rpm. The coating solution is applied for about 0.1 to 10.0 seconds, preferably for about 0.1 to 5.0 seconds, and most preferably for about 0.1 to 1.0 seconds. The coating spin off speed is usually about the same or higher than the spin coating speed, and the spin off time is typically about one to ten seconds.

The flow rate for the coating composition is preferably between about 1 and about 100 milliliters per second, more preferably between 2.5 and 25 milliliters per second.

The desired dry film thickness of the coating is typically between 1.0 and 10.0 microns, more preferably between 4.0 and 6.0 microns.

In the case where the lens material is polycarbonate or some other material to which it is difficult to obtain adequate coating adhesion, a primer layer may be spin applied onto the surface to be coated before the spin application of the abrasion resistant coating composition. The primer layer will enhance the adhesion between polycarbonate and the coating layer. A polyurethane or acrylic type of primer is preferred. U.S. Pat. No. 5,310,577 discloses a primer consisting of a thermosetting polyurethane in at least one organic solvent, with the polyurethane being formed from a blocked isocyanate, which requires the application of heat to disassociate the blocking agent from the polyurethane so that the isocyanate group can then react with the active hydrogen of the polyol to further polymerize and crosslink the primer coating. Another polyurethane primer was described in U.S. Pat. No. 5,316,791, in which the primer consists of an aqueous polyurethane dispersion, and is dried in air at ambient or elevated temperatures. The disclosures of the above U.S. Patents are incorporated by reference herein.

The primer layer can be applied in the same way as the coating composition, although higher spin speeds and a reduced pump speed is typically used to prevent defects due to bubbles. Such bubbles can result from the entrapment of air, which is more likely to occur with the primer than with the siloxane coating. This is typically the nature of an aqueous polymeric dispersion at very low weight percent of nonvolatiles such as the primer solutions that are suitable for use with this invention. Typically, lower spin speeds are used during the application of the primer than are used for the application of the abrasion resistant siloxane coating. This too is to prevent air entrainment and the concomitant coating defects. Typically, the spin off speeds for the primer will be higher than for abrasion resistant siloxane coating, since this will provide a thinner film of more uniform thickness. The dry film thickness of the primer should be from about 0.1 microns to about 1.0 micron, preferably from about 0.1 to about 0.5 microns, most preferably from 0.1 to 0.25 microns.

According to the third step of the process of the present invention, the coated lens is transferred into a chamber to accomplish what is called a precure in which the lens dries to a tack free state and the earliest stages of polymerization, crosslinking, and curing commences.

The precure is accomplished using some combination of radiant and convective energy. Preferably this is a combination of radiant heat and convecting hot air. For the former it is desired that the infrared heat source be between 500° F. and 1500° F., preferably about 1,000° F. depending upon the distance from the lens, the cycle time, the coating formula, and the lens material. For the latter, it is preferred that the air temperature be between about 150° F. to 600° F., preferably 250° F. to 500° F. Many different heat sources may be used, such as a black body irradiator, convective heat source, or other energy source. The temperature of these energy sources will be considerably higher than what the lens itself will be heated to due to the short exposure time to the heat source that is experienced by the lens during the precure process.

Heating may be affected using any known means commonly used in the art for thermal curing, such as a convection oven or infrared radiation. Heating using infrared radiation is preferred since it allows obtaining high temperatures within a very short period of time. A combination of infrared radiation and convection hot air flow is preferred to decrease the precuring time. The coated lens surface is generally maintained at a distance of from two to twenty centimeters, preferably five to ten centimeters, from the very high temperature infrared source during the heating step.

The duration of this thermal precure will depend on the several factors including the temperature of the heat source, the distance from the heat source, the formulation of the coating composition, and the thickness of the coating. However, the present process allows for the use of relatively short thermal precuring times of usually less than thirty seconds, often less than fifteen seconds, and sometimes less than ten seconds in air.

According to the fourth step of the process of the present invention, the lens with a precured coating is taken out of the spin coater and transferred into a convection oven to fully cure the coating to a final cure state. The final cure of the coating is completed by heat curing at temperatures in the range of 200° F. to 300° F. for a period of from about five minutes to about twelve hours.

For lenses made from a thermoplastic polymer such as bisphenol A polycarbonate, it is preferred to cure the coating at a temperature that is slightly lower than the glass transition temperature of the polymer. For bisphenol A polycarbonate lenses, the proper curing temperature is between about 200° F. and 300° F., typically about 250° F. The coating composition of this invention is preferably final cured at 265° F. for four hours in a forced air electric oven. The use of a gas fired oven may result in the development of color bodies as a result of the oxidation of the coating due to nitroxyl and other radicals that are present in the combustion gases if the plenum is defective or the oven is of such a design that the combustion gases are allowed to come into contact with the lenses.

### EXAMPLES

The process of the present invention will now be illustrated in more detail in reference to examples, which are for illustration purpose only and should not in any way be construed as a limitation upon the scope of this invention.

The abrasion resistance is expressed as the Bayer ratio, which shows the relative abrasion resistance of the test specimen as compared to a standard lens, which is commonly manufactured and used as a benchmark in the ophthalmic lens industry. Higher Bayer ratios indicate greater degrees of abrasion resistance. The Bayer ratio is determined by making percent haze measurements of a test specimen that is to be measured and an uncoated standard reference lens. The haze measurements of each are made both before and after the lenses are concurrently abraded in an oscillating sand abrader as in ASTM test method F 735-81. Uncoated CR-39® (poly[di(ethylene glycol) bis(allyl carbonate)]) lenses are used as the uncoated standard reference lenses. The abrader is oscillated for 300 cycles with 500 grams of aluminum zirconium oxide, ZF 152412 as supplied by Saint Gobain Industrial Ceramics, New Bond Street, P.O. Box 15137, Worcester, Mass. 01615-00137. The haze is measured using a hazeguard plus haze meter from BYK Gardner. The Bayer ratio is expressed as:

$$Bayer ratio = \frac{\begin{matrix}final percent haze of standard - \\ initial percent haze of standard\end{matrix}}{\begin{matrix}final percent haze of specimen - \\ initial percent haze of specimen\end{matrix}}$$

The adhesion of the coating is determined by ASTM test method D 3359-95A, which is widely known and commonly used throughout the coatings industry.

Interference fringes of the coating layer are observed with bare eyes under fluorescent light but are more visible under monochromatic light.

### Example 1

Spin applied thermally cured coating: A nominal 6 base semifinished single vision lens was put into a Super Lens Coater from Lightwave Energy Systems. The lens was washed in the coater for ten seconds by spraying with deionized water at 1,500 psi while concurrently spinning the lens at 1,000 rpm. The lens was spun to dry it for five seconds after the cessation of the deionized water spray. A waterborne aliphatic polyurethane dispersion was then applied as a primer by spraying the solution at room temperature onto the center of the lens for one second as the lens was spinning at 500 rpm. Immediately after completing the spraying of the primer, the lens was spun at 2,000 rpm for one second. The lens was immediately dried by a ten second exposure to a source of infrared light. The lens was again put into the above Super Lens Coater and a scratch resistant coating solution at 60° F. was then sprayed onto the lens while spinning the lens at 250 rpm for five seconds. The lens was spun for one second at 500 rpm after the cessation of the coating spray. The lens was immediately exposed to a source of infrared light for thirty seconds. The coating was then fully cured by placing it in an oven at 265° F. for four hours.

The lens was then cooled to room temperature and allowed to stand at room temperature to equilibrate for at least 24 hours before testing.

The performance of the coating was measured and determined to be the same as similar coatings that had been dip applied. However, the coating exhibited fewer interference fringes on the back surface of the lens compared to many interference fringes exhibited by the back sides of identical lenses to which the same coating had been dip applied.

### Comparative Example 1

Dip Applied Thermally Cured Coating: The coating of this comparative example has the same composition as the coating that is used in Example 1 but was applied by the following typical dip application process. A nominal 6 base semifinished single vision lens was cleaned by being sprayed with purified deionizing air before being immersed into a filtered recirculating aqueous detergent bath at 140° F. containing anionic detergents, nonionic detergents, 2-butoxyethanol, and sodium hydroxide with sweep frequency ultrasonics. The lens is then rinsed in a series of ultrasonic deionized water rinse baths at 140° F. to remove any trace residues of detergents or particle contamination. The lens is dried by a very slow withdrawal from the last rinse tank followed by passing the lens over a hot air knife.

After cooling in purified air for several minutes to achieve a temperature below 100° F., the lens is immersed into the waterborne aliphatic polyurethane dispersion solution of Example 1 at 80° F., which primer solution is being recirculated through a 5.0 micron absolute pleated polypropylene filter. The lens is withdrawn from the primer solution at such a rate that the dry film thickness of the primer will be very nearly 0.25 microns.

The primer layer is dried for 8 minutes at 125° F. before immersing the lens into the coating solution of Example 1 at 60° F., which coating solution is being recirculated through a 5.0 micron absolute pleated polypropylene filter. The lens is withdrawn from the coating solution at such a rate that the dry film thickness of the coating will be very nearly 5.0 microns.

The coating is precured in a clean forced air oven for one hour at 160° F. before being fully cured in a forced air oven for four hours at 265° F.

### Comparative Example 2

Spin Applied Radiation Cured Coating: The coating for this comparative example is SHC-175 from Lens Technology, 14256 Firestone Boulevard, La Mirada, Calif. 90638-5524, and has a formula that is based on acrylate monomers with a photoinitiator as opposed to the siloxane monomers that are used in the coating of the present invention. However, the coating of this comparative example was applied with a spin application process using an ASC-500 automatic spin coater from Calmation, 2380 Shasta Way, Simi Valley, Calif. 93065. By this process, the lens is first washed with a high pressure spray of deionized water at 3,000 psi whole spinning at 1,000 rpm after which the lens is dried by blowing 50 psi purified air at the lens as it spins at 1,000 rpm. The radiation curable coating solution is then applied to the lens by spraying while spinning the lens at 750 rpm. The lens is held at over heat source for five seconds to facilitate the evaporation of the solvents before curing the coating by being irradiated with ultraviolet light from a Fusion System, 910 Clopper Road, Gaithersburg, Md. 20878-1357, curing unit with an H+ bulb.

TABLE 1

| | Bayer | | Interference | AR |
|---|---|---|---|---|
| | Ratio | Adhesion | Fringes | Coatability |
| Example 1 | 5.0 | Passed | Minimal | Excellent |
| Comparative Example | 5.0 | Passed | Numerous | Excellent |
| 1 | | | | |
| Comparative Example | 1.5 | Passed | Minimal | Fair |
| 2 | | | | |

What is claimed is:

1. A method of coating an optical element comprising:
washing an optical element with a high pressure water spray;
drying the optical element,
applying an aqueous organic solvent coating to at least one surface of the optical element while the optical element spins;
thermally precuring the aqueous organic solvent coating to a tack free state; and
thermally curing the aqueous organic solvent coating.

2. The method of coating an optical element according to claim 1, wherein the aqueous organic solvent coating comprises hydrolysis products and partial condensates of an organic functional silane, a tetrafunctional silane, a multifunctional compound, and an amount of water sufficient to hydrolyze the epoxy functional silane and tetrafunctional silane.

3. The method of coating an optical element according to claim 2, wherein the multifunctional compound is multifunctional carboxylic acids, multifunctional anhydrides and combinations thereof.

4. The method of coating an optical element according to claim 2, wherein the multifunctional compound is multifunctional anhydrides.

5. The method of coating an optical element according to claim 1, wherein the thermal procuring is less than 10 minutes at a temperature range of about 150° F. to 300° F.

6. The method of coating an optical element according to claim 1, wherein the thermal curing is performed at a temperature range of about 150° F. to 400° F.

7. The method of coating an optical element according to claim 1, wherein the organic functional silane is selected from a group consisting of epoxy silanes, amino silanes, hydroxyalkyl silanes, carboxylic acid functional silanes, and isocyanate functional silanes.

8. The method of coating an optical element according to claim 6, wherein the epoxy silane compound containing at least one epoxy group and at least two alkoxy groups directly bonded to the silicon atom of the molecule has the formula: 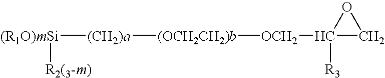
wherein R₁ is an alkyl or alkoxy alkyl group having 1 to 4 carbon atoms; R₂ is an alkyl or aryl group having 1 to 6 carbons atoms; R₃ is hydrogen or methyl group; m is 2 or 3; a is an integer from 1 to 6; and b is 0, 1 or 2.

9. The method coating an optical element according to claim 7, wherein the silane compound containing at least one epoxy group and at least two alkoxy groups directly bonded to the silicon atom of the molecule is selected from the group consisting of 3-glycidoxypropyltrimethoxysilane, 3-glycidoxypropyltriethoxysilane, 3-glycidoxypropylmethyidimethoxysilane, 3-glycidoxypropylmethyidiethoxysilane, 3-glycidoxyethoxypropylmethyidimethoxysilane, and mixtures thereof.

10. An optical element comprising:
a lens substrate; and
an aqueous organic solvent coating on at least one side of the optical substrate having been applied by spin coating, followed by a thermal pre-cure, followed by a thermal cure.

11. The optical element of claim 10 wherein the aqueous organic solvent coating comprises hydrolysis products and partial condensates of an organic functional silane, a tetrafunctional silane, a multifunctional compound, and an amount of water sufficient to hydrolyze the epoxy functional silane and tetrafunctional silane.

12. A method of coating an eye element comprising:
providing a thermally curable coating;
spin coating one surface of said eye element with said thermally curable coating;
thermally pre-curing the coating to a substantially tack-free state;
curing the coating to its final state.

13. A method of coating according to claim 12, wherein said thermal pre-cure lasts no longer than about ten minutes at a temperature in the range of about 150° F. to 300° F.

14. A method of coating according to claim 12, wherein the thermal curing lasts for a predetermined period of time at a temperature in the range of about 150° F. to 400° F.

15. A method of coating according to claim 12, wherein the thermally curable coating provided is an aqueous organic solvent coating comprises hydrolysis products and partial condensates of an organic functional silane, a tetrafunctional silane, a multifunctional compound, and an amount of water sufficient to hydrolyze the epoxy functional silane and tetrafunctional silane.
